(19) United States
(12) Patent Application Publication
(10) Pub. No.: US 2008/0248163 A1
(43) Pub. Date: Oct. 9, 2008

(54) BUTTER RELATED FOOD PRODUCT AND METHOD

(76) Inventor: Kelly Cox, Camano Island, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 12/098,392

(22) Filed: Apr. 4, 2008

Related U.S. Application Data
(60) Provisional application No. 60/975,050, filed on Sep. 25, 2007.
(60) Provisional application No. 60/910,357, filed on Apr. 5, 2007.

(51) Int. Cl. A23C 15/12

(52) U.S. Cl. 426/61; 426/581; 426/71

(57) ABSTRACT

A butter related food product comprising a water component and a hydrocolloid dietary fiber component with a butter component. In one embodiment, at least a portion of the water component and the dietary fiber component are mixed to form a hydrocolloid mixture, and this mixture is in turn mixed with the butter component. Inulin as a dietary fiber is utilized in many instances. The butter related product can advantageously be used in various food recipes where there is butter and also sugar as two of the components. The actual butter fraction would be substituted for all or part of the butter in the recipe, and also the sweetness provided by the inulin would reduce all or part of the sugar in the recipe. In another embodiment the buttermilk MFGM that is derived from churning the cream that is being processed in a butter churn is able to function as the water component of the mixture.

### RELATED APPLICATIONS

This application claims priority benefit of U.S. Ser. No. 60/975,050, filed Sep. 25, 2007, and U.S. Ser. No. 60/910,357, filed Apr. 5, 2007.

### BACKGROUND OF THE DISCLOSURE

a) Field of the Disclosure

The present invention relates to a butter related food product and more particularly to a butter-fiber food product. This food product may be used in a manner similar to conventional butter, and also in various related applications, such as being added to other food products.

b) Background Art

There is record of the use of butter as food as early as four thousand (4,000) years ago. Accordingly, it can reasonably be assumed that in these last 4,000 years there has been considerable improvement in the manufacture of butter.

The earliest details of method of manufacture are thought to be derived from the Arabs and the Syrians, where an animal is skinned, with the skin being sewed up tight, leaving an opening where the cream is poured in. The “churn” was then suspended from tent poles and swung until it became butter.

In more recent years, people have become more diet conscious and there is a stronger trend toward inducements directed toward reducing the amount of fat in a person's diet. For example, there are various butter simulated products being offered. However, for many people in the United States, a certain amount of butter still remains as part of their regular diet. At the same time, quite often efforts are made to reduce the consumption of fat in the diet by making reductions of fat in other types of food products.

Further, in recent years, the presence of dietary fibers in various food products is becoming more common, and these are valued for their health inducing effects. Although some confusion seems to exist about the benefits of soluble or non-soluble dietary fibers, global heath records clearly demonstrate that in cultures where adequate dietary fiber is consumed, there is an absence, for all practical purposes, of what we have come to know as “rich country” ailments and diseases.

Further, scientific research has demonstrated, and continues to demonstrate, the efficacy of hypocholesteramic adjuvant, soluble dietary fibers. Accordingly, it can be surmised that for many people (or most people) a diet that reduces dietary fat intake and encourages the beneficial effects of dietary fibers can benefit a person's health.

It is toward these goals that the embodiments of the present invention are directed.

### SUMMARY OF THE DISCLOSURE

The embodiments of the present invention comprise methods of combining three basic components, namely, a butter component, a water component, and a hydrocolloid dietary fiber component to make a desirable food product. In one embodiment the water component comprises primarily water with no significant additives, and another embodiment combining as the water component a Buttermilk MFGM.

In the process, the water component and the dietary fiber component are mixed to have them combined into a colloid state, and these are then mixed with butter to form the end product.

### BRIEF DESCRIPTION OF THE DRAWINGS

FIG. 1 is a semi-schematic view of an automated system for practicing the method of a first embodiment of the present invention;

FIG. 2 is a schematic drawing similar to FIG. 1, showing a modified form of the first embodiment; and

FIG. 3 is a view similar to FIGS. 1 and 2 showing a second embodiment of the present invention.

### DESCRIPTION OF THE EMBODIMENTS

### A) A First Embodiment

### a) The Ingredients Used

There are three basic components which are combined to make the food product of the present invention; these are:
a butter component;
a water component; and
a hydrocolloid dietary fiber component.

i) The Butter Component
The butter of the butter component can be defined as a fatty substance which results from churning cream that is separated from milk and the butter can be butter which can be purchased in most any grocery store or supermarket or wholesale bulk butter. Also, this butter includes all three grades of butter, namely:
   U.S. Grade AA;
   U.S. Grade A; and
   U.S. Grade B.
Further, the butter within the scope of the present invention can be combined with a small percent of additives, such as salt.

ii) The Water Component
The water component includes water with or without additives or other material or materials, and also can be water which is already combined with other materials.

iii) The Dietary Fiber Component
The dietary fiber component is within a class of dietary fibers which are able to function as a “hydrocolloid” component in a colloid system.
The term hydrocolloid is defined in one dictionary (i.e., the Wikipedia Dictionary) as follows:
   “A hydrocolloid is defined as a colloid system where the colloid particles are dispersed in water. A colloid system is simply a system or mixture in which two substances are interspersed between each other. A hydrocolloid has colloid particles spread throughout water and depending on the quantity of water available can take on different states, e.g., gel or soluable (liquid). Hydrocolloids can be either irreversible (single state) or reversible. For example, agar, a reversible hydrocolloid of seaweed extract, can exist in a gel and soluable state and alternate between states with the addition or elimination of heat.
   Many hydrocolloids are derived from natural sources. For example, carrageenan is extracted from seaweed, gelatin has bovine (cow) and fish origins and pectin is extracted from citrus peel and apple pomace.
   Jell-O (trade mark Jell-O), the well-known dessert, is made from gelatin powder, another effective hydrocolloid.”
During the development stage of these embodiments when different formulations and procedures were used in the testing process, the inventor was quite often using inulin as the dietary fiber. Thus, in the following text, the dietary fiber component will often be designated as “inulin” since it has certain characteristics which are advantageous in the embodiments of the invention. However, it is to be understood that in a broader sense, the term inulin would be interpreted more broadly to include other dietary fibers.
By way of background information, inulin was isolated in about 1804, but not put into production until about 1995. Since then it has been used in various ways. For example, yogurt companies have incorporated inulin into their yogurt to increase fiber content. Proctor & Gamble has more recently introduced a product referred to as FIBER SURE. A teaspoon of this pure inulin known as FIBER SURE can be added to a glass of water, orange juice, spaghetti, or salad, presumably to help increase dietary intake of fiber. Also, inulin is finding its way into health drinks, and in confectionary, and in chocolate bars.
Inulin is a soluble dietary fiber derived from possibly as many as about 30,000 different vegetation plants from around the world. It is a mixture of non-digestible fructose units linked together by (2-1) linkages terminated by a glucose unit. The primary source which is used commercially is derived from chicory root or Jerusalem Artichokes. Inulin is a generic term, and it is a fructo-ologasicride and considered to be a hydrocolloid that is refined with a hot water process. Inulin is a white powder that has a slightly sweet flavor. However, it is not considered a sugar, and it is diabetic friendly; it doesn't affect glycemic levels and does not cause stimulation of insulin excretion.
However, it is to be understood that there are other dietary fibers that are within the category of being a “hydrocolloid” and meant to be included as candidates within the scope of at least some aspects of the embodiments of the invention.
Among these are the following:
   Arabic gum
   Algin
   Bensal
   Locust bean tara
   Karaya
   Guar
   Oat
   Ghatti
   Guince
   Sapote
   Watsonia
   Tamarind
   Psyllium
   Tragacanth
   Xanthan
   Furcelleran
   Dextran
   Chondritin sulfate
   Chitosan
   Xylan
   Propol
   Carrageenan
   Agar
   Pectin

### b) Method of Combining These Ingredients to Form the End Product of the First Embodiment.

As an initial step, the desired quantity of the dietary fiber compound (e.g. inulin) and the water component are mixed with one another so that these progress into a hydrocolloid state. For convenience, in this portion of the text the terms “dietary fiber component” and “water component” will simply be referred to as the inulin and the water. The water should be at a temperature of between thirty-five (35°) degrees to one hundred-fifteen 115°) degrees Fahrenheit. This mixing of the water and inulin should be done continuously up until the time it is to be mixed with the butter. The inulin/water dispersion should be at (or cooled to) about forty (40°) to seventy-five (75°) degrees Fahrenheit prior to being mixed with the butter, with sixty-two degrees (62° F.) Fahrenheit being an optimized or near optimized temperature level.

The packaging apparatus for butter (a print machine) is temperature sensitive, and this shall influence this temperature. When the inulin is blended with the water at a higher temperature, it is more fluid. However, as the water is allowed cool down, then the mixture would become more gel-like and maintain its shape.

At this time the water and inulin colloid mixture is mixed with the butter. When the colloid mixture is mixed with the butter, it first forms an aggregate, and as mixing continues, there is then formed a matrix and eventually a gel. If the inulin and the water are not properly blended together prior to adding these to the butter, it can happen that some of the inulin would bond directly to the fat in the butter, and not the combination of the inulin/water emulsion where the water and the inulin formed the emulsion. Therefore, it should be ensured that there is a proper mixing of the water with the inulin.

In some of the initial development work that was done by the inventor, it was concluded that when the inulin/water colloid was being mixed with the butter, the mixing action should be more of a general mixing action without large sheer forces being created. However, later research indicates that this may not necessarily be true in all instances since other types of mixing devices of various sorts have been used and have achieved comparable results. The following commercial blenders could be used, namely:
i) Ribbon Blender Horizontal
ii) Hobart Orbital Stand Mixer
iii) Lightnen Mixer Single Shaft Vertical
iv) In Line Static Mixer

After the above steps are accomplished, the resulting product in the form of a gel can be packaged (possibly in the same way butter is packaged) or as an end product. Alternatively, it may be that this could possibly be combined with some other ingredient or ingredients to form a derivative product in its own right. Some of these possibilities are discussed later in this text.

### c) Relative Quantities of the Ingredients.

In the development of the embodiments, various percentages by weight of combinations of ingredients were tried, and among these are the following:

| Butter | Inulin | Water |
|---|---|---|
| 64% | 22% | 14% |
| 52 | 30 | 18 |
| 75 | 24 | 1 |
| 77 | 5 | 18 |
| 69 | 30 | 1 |
| 94 | 5 | 1 |

The results were that the ratios of 64% butter, 22% inulin and 14% water turned out to be quite satisfactory. Also, the formulation of 52% butter, 30% inulin and 14% water were tried and these also resulted in a quality end product.

In the formulation of 77% butter, 5% inulin and 18% water, the dietary benefits of the end product were substantially compromised, and there was something of an excess of water. The effect of this is sweating or breaking due to the lack of fibers to hold the emulsion or gel.

In the formulation where there was 69% butter, 30% inulin and 1% water, the overall texture of the butter-related product was what could be described as “gritty”.

Both the 22% inulin and 14% water mixture and also the 30% inulin and 18% water mixture were also quite satisfactory. The water to inulin ratios for the two mixtures given in the prior sentence are 1 to 1.57 and 1 to 1.67 respectively. Accordingly, a middle compromise would be approximately a 1 to 1.6 ratio of water to inulin to obtain the quite adequate mixture.

However, these ratios given by weight in the above paragraph could possibly be broadened out somewhat so that the ratios could be as low as 1 to 1.5, 1 to 1.4, or 1 to 1.3, or 1 to 1.2, or 1.1, or possibly lower when an excess of water could be tolerated. Then the ratios could possibly be broadened to 1 to 1.7, 1 to 8, 1 to 1.9, 1 to 2, 1 to 2.2, 1 to 2.4, 1 to 2.6, 1 to 2.8, 1 to 3 or possibly higher. However, the quality of the end product would likely be diminished in some respects with substantial departure from the 1 to 1.6 ratio.

In comparing the two more optimized examples (one of which has 52% butter, 30% inulin and 18% water) with a second ratio mixture (64% butter, 22% inulin and 14% water), the lowered amount of butter in the first example would cause the end product to have less of a butter taste, but on the other hand it would likely get more of the benefits of having the benefits of inulin. Further, it would simply be a reversal of these if we go to the example of higher percentage of butter so that there would be more of the butter taste, but with less desirable results in compromising the benefits of having more inulin as an ingredient.

In one of the tests where there was 77% butter, 5% inulin and 18% water, some benefit can be obtained, but the main downside is that there would be an unnecessarily large amount of water present.

### d) Apparatus for Making the Butter/Fiber Product.

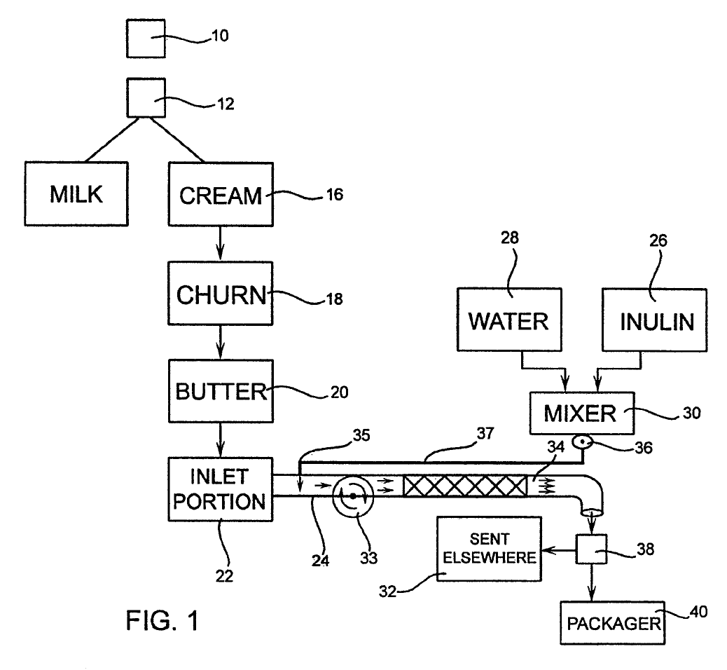

If the method of making the butter related product is to be accomplished in a larger scale operation with automated equipment, the following procedure that is illustrated in FIG. 1 could be used.

First, the whole milk 10 that is to be used to provide the butter goes through a separation process at 12 to divide the milk portion 14 from the cream 16. The milk is directed to be used at some other location, and the cream would be directed into a butter churn 18 which functions to deliver a continuous flow of butter 20. This continuous flow of butter is directed into an inlet portion 22 of a conduit 24 (e.g., a two and one-half inch feed pipe) at an upstream flow location.

At the same time the inulin 26 and the water 28 are being mixed on a continuous basis in the mixer 30, and the resulting colloidal mixture is directed by a metering pump 36 to travel through a pipe 37 to an injection quill location 35 at an upstream end of the conduit 24 to be moved by a positive displacement pump 33 into an inline static mixer 34 which mixes the ingredients as it moves the ingredients in a downstream direction.

When the butter/inulin/water mixture reaches the discharge location 38, the mixing steps have provided the mixture in the form of an end product. This end product could be collected and sent elsewhere at 32 to be used at some other location. Or it could be packaged at 40 in some manner. For example, the end product could be directed to an automated machine that packages butter, this being known as a print machine.

### e) Characteristics of the Butter/Inulin/Product.

Due to the structure of the molecules of inulin, the end product has a semi-sweet taste. This in turn provides various advantages. First, the butter related product has, while still maintaining the basic taste of butter, what some people regard as something of a sweet taste to the butter. Although some people will describe this in different words, it does have what has been regarded by those using it as a distinctive and pleasant taste.

Beyond the butter being tasty in its own right, the effect of the inulin in the butter also shows up in other ways. For example, there is flavor enhancement of the butter related product that results with being subjected to a relatively high temperature. For example, if it is used as a coating for some other food (e.g., a chicken, meat, etc.) present analysis indicates that the inulin component will, because of its sweetness, caramelize to some extent and thus give a desirable effect.

Also, when the butter/inulin mixture (which also is termed as the “butter related product”) is utilized as a substitute for butter when some food is being cooked in a frying pan, flavor can be added. It is believed that the saccharide portion of the inulin and/or glucose being caramelized is responsible for this taste.

As indicated above, the butter related product (i.e., the butter/inulin/water mixture) can get used as a substitute for butter in various baked food products or other types of food products. One example of this is where cookies are baked using the butter related product in place of the butter in the recipe. The main ingredients in the recipe for the cookies were flour, sugar, butter, salt and baking soda.

However, the amount of sugar was reduced by up to thirty (30%) percent and this was replaced by the butter product of the present invention. There was no noticeable lowering of the sweetness of the cookie product, the reason being that sufficient sweetness was provided by the inulin to balance this out.

Also, in terms of taste and feel, in making these cookies there was no noticeable degradation as to organileptic properties (the term organileptic being related to various senses of smell, texture, and how these react in the organs). Also, one of the side benefits of using the butter-related product in the cookies is that the cookies had an appearance which would reflect light and give a better appearance.

Further, it has been observed that when the inulin is used in connection with, for example, frying eggs, it does very well in providing a “non-stick” function. Also, in being used in a frying pan where fried eggs are being made, quite often if there is any moisture this will pop up toward a person's face or hands. However, this was not observed with this butter related product. On top of that, due to its “non-stick” characteristics, the egg whites are held more closely around the yolk.

With regard to shelf-life, it has been observed that with the mixture of the end product being placed in a refrigerator it has substantially the same shelf life.

### EXAMPLES OF MAKING THE BUTTER/FIBER PRODUCT

### Example No. 1

453 grams of butter at room temperature of 72° F. was measured out using a lab tech gram scale. The butter was then put into a 5-quart stainless steel Hobart mixing bowl. The bowl with the butter was then attached to the Hobart stand mixer, power off. 80 grams of water at 90° F. was measured by weight on said scale and put into an Oster Home Blender. The blender was switched on low speed to create a vortex. 100 grams of guar gum was measured by weight on said scale and added to the center of the water vortex in the home blender still on low to facilitate an evenly dispersed powder in water mixture and turned into a thin liquid gel in 1-2 minutes mixing time. This mixture of water and guar gum was then added to the butter in the Hobart mixer with the power on low and blended until a water-in-oil emulsion was formed, 3-5 minutes mixing time. This emulsion was then poured into a wax paper lined mold and placed in a standard subzero home refrigerator at 34 degrees for 12 hours. Texture was good. Taste was good. Color was light tan.

### Example No. 2

453 grams of butter at room temperature of 72° F. was measured out using a lab tech gram scale. The butter was then put into a 5-quart stainless steel Hobart mixing bowl. The bowl with the butter was then attached to the Hobart stand mixer, power off. 80 grams of water at 90° F. was measured by weight on said scale and put into an Oster Home Blender. The blender was switched on low speed to create a vortex. 80 grams of psyllium was measured by weight on said scale and added to the center of the water vortex in the home blender still on low to facilitate an evenly dispersed powder in water mixture and turned into a thin liquid gel in 1-2 minutes mixing time. This mixture of water and psyllium was then added to the butter in the Hobart mixer with the power on low and blended until a water-in-oil emulsion was formed, 3-5 minutes mixing time. This emulsion was then poured into a wax paper lined mold and placed in a standard subzero home refrigerator at 34 degrees for 12 hours. Color was brown. Taste was good. Texture was grainy.

### Example No. 3

453 grams of butter at room temperature of 72° F. was measured out using a lab tech gram scale. The butter was then put into a 5-quart stainless steel Hobart mixing bowl. The bowl with the butter was then attached to the Hobart stand mixers power off. 75 grams of water at 90° F. was measured by weight on said scale and put into an Oster Home Blender. The blender was switched on low speed to create a vortex. 80 grams of inulin was measured by weight on said scale and added to the center of the water vortex in the home blender still on low to facilitate an evenly dispersed powder in water mixture and turned into a thin liquid gel in 1-2 minutes mixing time. This mixture of water and inulin was then added to the butter in the Hobart mixer with the power on low and blended until a water-in-oil emulsion was formed, 3-5 minutes mixing time. This emulsion was then poured into a wax paper lined mold and placed in a standard subzero home refrigerator at 34 degrees for 12 hours. This was a workable product.

### Example No. 4

453 grams of butter at room temperature of 72° F. was measured out using a lab tech gram scale. The butter was then put into a 5-quart stainless steel Hobart mixing bowl. The bowl with the butter was then attached to the Hobart stand mixer, power off. 80 grams of water at 90° F. was measured by weight on said scale and put into an Oster Home Blender. The blender was switched on low speed to create a vortex. 150 grams of inulin was measured by weight on said scale and added to the center of the water vortex in the home blender still on low to facilitate an evenly dispersed powder in water mixture and turned into a thin liquid gel in 1-2 minutes mixing time. This mixture of water and inulin was then added to the butter in the Hobart mixer with the power on low and blended until a water-in-oil emulsion was formed, 3-5 minutes mixing time. This emulsion was then poured into a wax paper lined mold and placed in a standard subzero home refrigerator at 34 degrees for 12 hours. Texture, taste, and color made this a very good product.

### Examples of Using the Butter/Fiber Product in Making Baked Food Products

In this section, there are given four examples where a recipe for a baked food product is given as it exists in the prior art called the prior art method, and then there is the recipe and procedure for a comparable recipe and method using the Butter/Fiber product.

In each of these following four examples, there is first given the prior art recipe for three baked food products and then a frosting for baked food products. Then for each baked recipe and frosting recipe a recipe made in accordance with the present invention is given where the amount of butter in the prior art recipe is reduced. At the same time, the amount of sugar is decreased, and this can be done since the sweetness contributed by the Butter/Fiber product makes up for the loss of sweetness caused by the reduced amount of sugar. In each of these examples, inulin with its health benefits is the fiber that is used in the recipe in accordance with the present invention.

### Example No. 5

The prior art recipe is given below.

Banana Bread
½ cup butter
½ cup sugar
2 eggs
1½ cup flour
1 tsp baking soda
1 tsp salt
2 cup bananas
½ cup plain yogurt
1 tsp vanilla

One typical prior art method of making the Banana Bread in accordance with this recipe would be as follows:
i) the first three ingredients (½ cup butter, ½ cup sugar and 2 eggs) are mixed together to form a “cream mix” which is placed in a separate containing vessel;
ii) then the next three ingredients (1½ cup flour, 1 tsp baking soda, 1 tsp salt) are blended and also placed in a separate container;
iii) then the last three items (i.e., 2 cups bananas, ½ cup plain yogurt, 1 tsp vanilla) are blended and placed in yet a third container.
iv) The first three ingredients are then blended together, and then the blends of the second and third set of ingredients are alternately blended into the first group of ingredients (the ½ cup butter, ½ sugar, 2 eggs) until there is finally a reasonably homogeneous mixture. After this, the food product is cooked in an oven.

Then to illustrate the manner in which the Butter/Fiber product can reduce the amount of sugar and butter, there is presented the following recipe:

Banana Bread with Butter Fiber Product
½ cup Butter Fiber Product
⅓ cup sugar
2 eggs
1½ cup flour
1 tsp baking soda
1 tsp salt
2 cup bananas
½ cup plain yogurt
1 tsp vanilla

It can readily be seen that this second recipe using the Butter/Fiber product is the same as the prior art method except that instead of having ½ cup of sugar, there is only ⅓ cup of sugar along with ½ cup of Butterfi as opposed to ½ cup of pure butter.

This second Banana Bread product is made using the revised recipe of this embodiment of the present invention and using generally the same procedure that is described above as to how the ingredients are mixed and blended together prior to being baked. The overall taste and the sweetness of the Banana Bread made in accordance with the embodiments of the present invention were very close to being the same.

### Example No. 6

This example has a Sugar Cookie for the baked product and first there is given below the prior art recipe by which the prior art Sugar Cookie was made and then below there is basically the same recipe given in accordance with the embodiments of the present invention. In this instance there is also the result that both the sugar content and the amount of actual butter was reduced in the recipe used in accordance with the embodiments of the present invention.

Prior Art Recipe

Sugar Cookie
1½ cups sugar
⅔ cup shortening or butter
2 eggs
2 tablespoons milk
1 teaspoon vanilla extract
3¼ cups flour
2½ teaspoons baking powder
½ teaspoon salt

Recipe in the Present Butter/Fiber Product

Sugar Cookie with Butter Fiber Product
1 cup sugar
⅔ cup Butter Fiber Product
2 eggs
2 tablespoons milk
1 teaspoon vanilla extract
3¼ cups flour
2½ teaspoons baking powder
½ teaspoon salt

Again, the overall taste and sweetness was very close to being the same.

### Example No. 7

This seventh example involves the baking of White Cake, and the two recipes are given below.

Prior Art Recipe

White Cake
1 cup sugar
½ cup butter
2 eggs
2 tsp vanilla
1½ cup flour
1¾ tsp baking powder
½ milk

Recipe in the Present Butter Fiber Product

White Cake with Butter Fiber Product
⅔ cup sugar
½ Butter Fiber Product
2 eggs
2 tsp vanilla
1½ cup flour
1¾ tsp baking powder
½ milk

This accomplishes the same result as noted in Examples 5 and 6 above, and again there is a product which in taste and other characteristics, the two products were substantially the same (or possibly indistinguishable).

### Example No. 8

In this eighth example, instead of making a baked product, there is a recipe for making a frosting.

Prior Art

Frosting
⅓ cup butter
¼ tsp salt
1 tsp vanilla
3½ cup confectioners sugar
3-4 Tbsp milk

Recipe in the Present Butter Fiber Product

Frosting with Butter Fiber Product
⅓ cup Butter Fiber Product
¼ tsp salt
1 tsp vanilla
2⅓ cup confectioners sugar
3-4 Tbsp milk

### f) Various Advantages of the Butter/Inulin Combination

There are a number of advantages or various nutritional and health benefits that can result from use of this butter related product, and among these are the following:
i. This food product is relatively lower in cholesterol due to the displacement of the quantity of the butter by the fiber and water, and also for this reason lower in fat content.
ii. This food product can also lower the amount of salt in the food product as compared to conventional butter.
iii. The inulin content helps absorption of calcium in humans.
iv. It is also surmised that the soluble dietary fiber content provided by the inulin would be found to aid in binding some of the ingested cholesterol so that it may be sequestered in the digestive system and not enter the blood stream.
v. Also, present analysis and/or research indicates that a characteristic of inulin is that it promotes the propagation of the bifid bacteria (i.e., a prebiotic to support the probiotic bacteria) in the digestive tract, which would be beneficial to a person's health.
vi. This could be attractive possibly to a person who is in the hospital and is fed vitamins or other prescribed nutritional food products or possibly even medicinal products.
vii. Also, the end product of the butter-related product could be mixed with other ingredients beneficially. For example, the end product could be mixed with a Vitamin D and whipped up to approximately a 30% increase in volume.
viii. Also, the butter related product could be mixed with flavoring products (e.g., garlic, sage, etc.).

With regard to substituting other products for the inulin, one candidate which would produce beneficial results is pectin. It could accomplish some of the same results as obtained by the use of inulin, but it may not have quite the same sweetness.

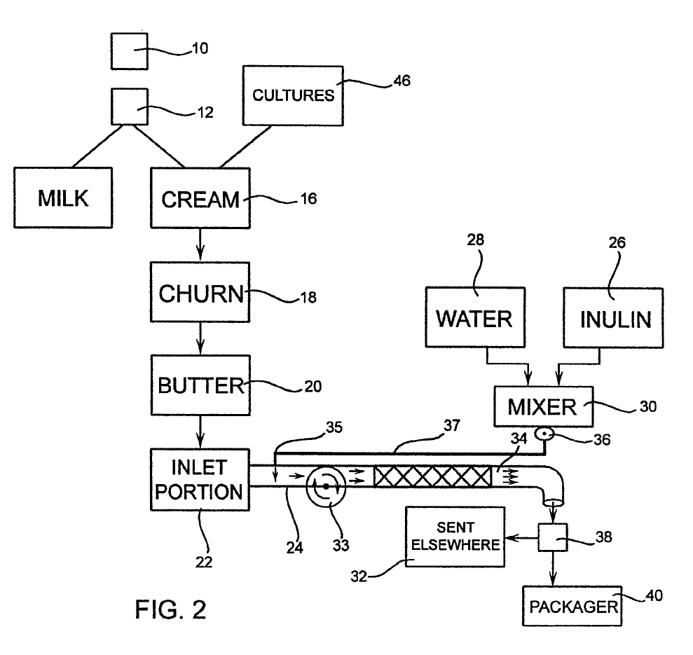

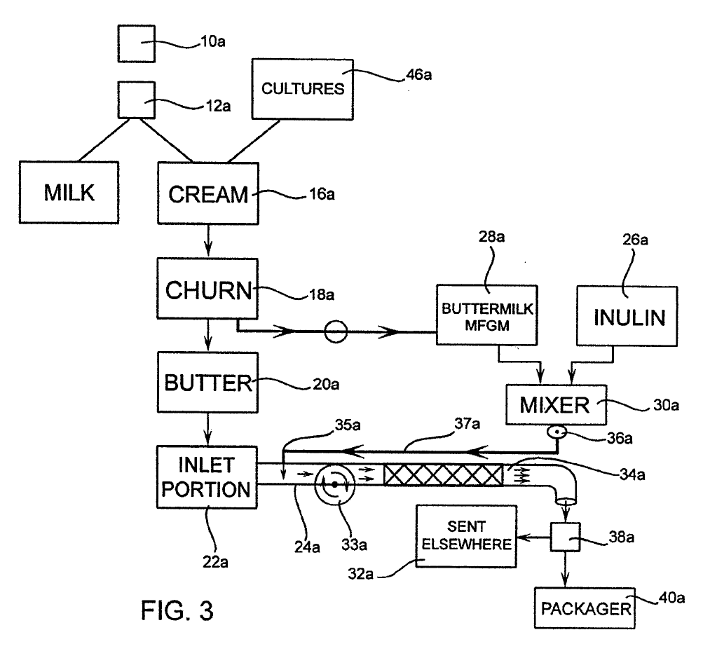

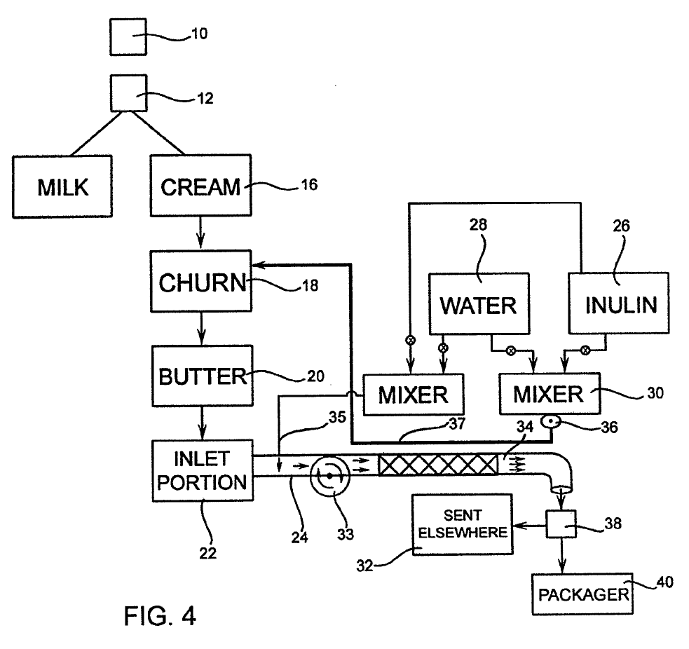

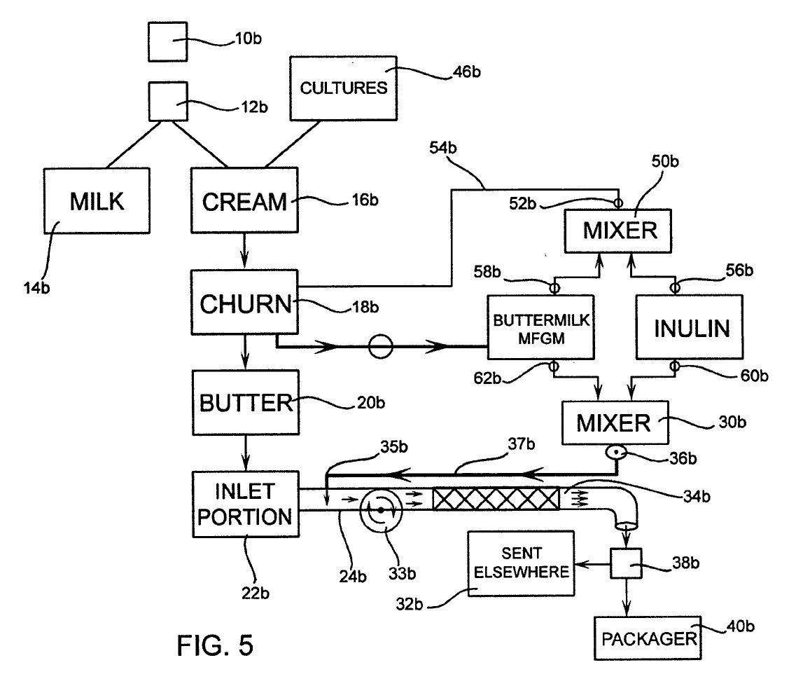

In both FIG. 2 and FIG. 3, there is a component which is designated “cultures 46” in FIG. 2 and “cultures 46a” in FIG. 3. One of the additional features of these embodiments is that various desirable components and/or ingredients can be incorporated into the cream 16 and end up in the end product to enhance its functions and/or advantages.

For example, in section “f” entitled “Various Advantages Of The Butter/Inulin Combination”, it is indicated in paragraph vi. that for a person who is in the hospital and is fed vitamins or other prescribed nutritional food products or possibly even medicinal products, could be incorporated into the cream supply to be contained in the end product.

Also, as an example, it has been found that yogurt could be mixed with the whole cream and the mixture can be let set for a period of time (e.g. 18 hours) so that before being churned the butter would already have grown probiotic bacteria. It would also be possible to have a variety of probiotic components actively added to the mixture.

### B. Second Embodiment of the Invention

The schematic drawing of FIG. 3 shows the second embodiment and it can readily be seen that FIG. 3 is rather similar to the schematic drawing of FIG. 1, which shows the first embodiment. Therefore, components of the second embodiment of FIG. 3 which are the same as, or similar to, components of the first embodiment of FIG. 1, will be given like-numerical designations with an “a” suffix distinguishing those of the second embodiment.

It readily becomes apparent by comparing FIG. 1 and FIG. 3 that the main difference in the second embodiment is that instead of simply indicating a source of water at 28 as in FIG. 1 that feeds into a mixer 30, there is in FIG. 3 an item 28a which is designated “Buttermilk MFGM”. Also, there is shown in FIG. 3 a feed-line designated 42a which extends from the churn 18a to the component 28a which, as indicated above, is designated “Buttermilk MFGM”.

There will now be a very brief summary of the system of FIG. 3, and then this will be followed by a more detailed explanation.

With continued reference to FIG. 3, the butter churn 18a may be the same as the butter churn 18 of FIG. 1. Both of these churns 18 and 18a are, or may be, commonly used churns that have been in existence for many years. When the cream enters the churn 18 or 18a, it is churned for approximately an hour and fifteen (1 hour and 15 minutes) minutes so that it can break up the milk-fat-globule-membranes to release the butterfat. As the cream is being transformed into butter, the butter itself drops down in both FIG. 1 and FIG. 3 from the location 20 or 20a and then down to the inlet portion 22 or 22a of the continuous mixer.

However, to understand more completely this second embodiment it is important to know not only that when the cream is churned there is what we could call a “bi-product” that is produced in the butter churning operation, but also to know the nature of this bi-product which is called “Buttermilk” or “Buttermilk MFGM”. The butterfat itself is a light-colored material that comes and becomes a big butter-ball. However, in addition to producing butter there is produced a thin white liquid which is called the “Buttermilk” or “Buttermilk MFGM” (which stands for “milk-fat-globule-membrane”).

In years past, it was more common to have this buttermilk bottled and sold as a product in its own right under the generic name “buttermilk”. However, that trend is apparently part of the past, and typically this buttermilk MFGM is now simply drained off either as a waste product or utilized in some food processes such as conditioning ice cream. But for the most part it simply goes down the drain.

Now let us return to our discussion of this second embodiment and go back to the buttermilk MFGM source 28a which is receiving buttermilk MFGM from the churn 18a and directing the MFGM product into the mixer 30a, along with the inulin at 26a, into the mixer 30a. A flow control valve 41 could be provided, or the buttermilk MFGM could be stored and used as needed. The two ingredients (i.e., the buttermilk MFGM and the inulin) are mixed and pumped by the metering pump 36a through the line 37a to the injection location 35a. Then the butter also enters into the injection quill location 35a and is moved by the displacement pump 33a into the inline static mixer 34a which mixes ingredients as it moves in the downstream direction.

From there the mixture is collected at the discharge location 38a and is either sent to the packager 40a or to some other location indicated at 32a. However, in terms of producing the product of this second embodiment, this second embodiment has some rather interesting and worthwhile features.

The MFGM has a variety of advantages. As an example, it helps build muscle; it helps bacteria in the colon; it helps absorb calcium; it inhibits cholesterol and helps grow the desirable fat related products.

Accordingly, this second embodiment is literally taking out of the butter a fraction which is the milk-fat-globule-membranes, conditioning it with inulin and then putting it back in the butter so that this results in a more full dairy product.

Also, it has been found that when the Buttermilk MFGM is mixed with the inulin, the mixing progresses as well as it would with the plain water of the first embodiment and properly form a colloid. In addition, there is the advantage that the Buttermilk MFGM has more probiotic bacteria as a benefit. Therefore, with the butter that has been cultured so that it is probiotic, and the inulin which is probiotic, these both cooperate to make an enhanced food product.

### C. Third Embodiment

A third embodiment of the present invention will now be described with reference to FIG. 4 which illustrates a continuous process. It is to be understood that within the broader scope of the embodiments of the present invention, there could be variations in the manner of combining the three main components (i.e., the water component, the hydrocolloid dietary fiber component, and the butter component). This third embodiment is one example of how this might advantageously be done.

It is believed that a better understanding of the functional features introduced in this third embodiment will be obtained by first identifying the components of this third embodiment which exist also in the first embodiment. In doing this, the components which are the same as (or similar to) the components of the earlier two embodiments will be given like numerical designations, with the suffix “b” distinguishing those of the third embodiment.

Thus, in FIG. 4, there are, as in the first embodiment, the whole milk 10b and the separation process 12b which separates the milk 14b and the cream 16b. The cream 16b is then directed to the churn 18b to make the butter 20b which is then directed to the inlet portion 22b of the conduit 24b. Then there is the source of the dietary fiber, which in this embodiment is indicated as the inulin indicated at 26b, and also the source of the water component 28b. As in the first embodiment, there is the mixer 30b into which the inulin 26b and the water 28b are directed, with the mixer 30b transmitting the colloidal mixture by a metering pump 36b to the inlet location 34b at the upstream end of the conduit 24b.

Then, with the butter being introduced into the inlet portion 22b, and with the mixture of the water and inulin from the mixture 30b being introduced at 35b, these components are directed into the in line static mixer 34b to exit at 38b to be either packaged (at 40b) or sent elsewhere.

The components that have been described thus far in this description of the third embodiment function in substantially the same manner as in the first embodiment, and the next step is to identify the newly added components and the operation of this third embodiment.

However, it is believed that the newly added features of this third embodiment would be better understood if this is preceded by a brief discussion of how common prior art churns function.

It is a common present day butter churn when the cream is introduced into the churn, there is a first phase called the “agitation phase” during which it separates the fat molecules from the whey of the MFGM, and the cream is in a more liquid phase as it is “agitated” for a period of time. Then the partially churned cream enters into the conditioning phase. During the conditioning phase, the cream is now in a stage where it continues thickening. Thus, in this conditioning phase, the resistance of the cream being made into butter becomes greater and is more resistant to the churning action. Accordingly, the power of the operating components in the conditioning is substantially greater.

When the prior art churn is being used only to make butter, at the end of the conditioning phase the butter has been completed and then it would be the common prior art practice for the butter to be either packaged or sent on for being employed in some other process. However, in the present invention the butter from the churn is directed into the inlet end of the stationary mixer to be combined with the water component and the dietary fiber component.

To describe now the newly added embodiments of the third embodiment, there is a second mixer 50b having a metering pump 52b which directs the mixed inulin and water component through a line 54b to the churn 18b. The inulin component 26b is fed through a control valve 56b into the second mixer 50b and the water component 28b is fed through its control valve 58b to the mixer.

With this arrangement shown in FIG. 4, it is now possible to direct some of the inulin 26b and/or water 28b through the mixer 50b to the churn 18b. As indicated above, the churn 18b could be a commonly used prior art churn, such as described above.

With the conditioning area of the churn having substantial power, it can be seen that there would be advantages in possibly having the conditioning phase of the churn take on more of the overall burden of completing the mixing of all of the three main components. With the arrangement of this third embodiment, there can be two sources of the water/inulin mixture. The inulin/water mixture obtained at the second mixer 50b could easily be made to have a higher percentage of inulin relative to the water so that it would be a more viscous mixture, and this would be introduced into the conditioning stage of the churn 18b where it is possible to apply more power into the mixing action.

This would result in the mixture from the first mixer 30b that is to be incorporated into the butter component to have a greater amount of water relative to the inulin which is directed to the first mixer 30b and then transmitted into the inlet portion of the static mixer 34b.

For example, let us assume that during the conditioning period a more condensed inulin mixture can be mixed for example with 25% of the water component of the total prescribed amount of water component for the final composition can be introduced along with 100% of the inulin to be thoroughly mixed in the initial butter composition. Thereafter the remainder of the 75% of the water component can be introduced through the mixer 36b for the mixing phase. When the inulin is to be mixed with the water component and added into the butter product in the churn, there would need to be about 25 grams of water for every 150 grams of inulin. However, to accomplish this ratio which is this high in terms of inulin to water component, the water component would have to be up to at least about 100° F.

To provide the inulin and the water components in the proper amount, there are provided the two control valves 56b and 58b. With regard to the supply of inulin, the valve 58b would be open to a greater extent to allow greater flow as compared to the control valve 58b of the water. Then the meter pump 52b would deliver the mixture that the water/inulin mixture at the desired rate through the conduit 54b to the conditioning section of the churn 18b.

At the same time, the first mixer 32b would be receiving its quantity of water and inulin through the two control valves 60b and 62b, and these components are in turn delivered by the meter pump 36b through the conduit 37b to be injected at 35b into the inlet end of the stationary mixer 34b.

A modified form of this third embodiment is shown on FIG. 5. This modification is to utilize the buttermilk MFGM from the churn 18b to function as the water component. In other respects, this modified form of this embodiment shown in FIG. 5 is substantially the same as what is shown in FIG. 4. Accordingly, there will not be any added description of this version of FIG. 5.

It is to be understood that various modifications could be made in the present invention without departing from the basic teachings of this invention. Further, there could be deletions, or addition of components which would be within the scope of the invention. Also, although there are shown a number of specific components, it is also evident that there could be substitutions or variations of same without departing from its basic teachings.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A method of making a butter/dietary fiber/water food product comprising:
a. providing a quantity of a water component and a quantity of a hydrocolloid dietary fiber component and mixing at least a portion of the water component and the hydrocolloid dietary component to form at least in part a water and dietary fiber colloid mixture; and
b. mixing said water component and said hydrocolloid dietary fiber component with a quantity of a butter component to form said food product.

2. The method of claim 1, wherein;
a. the quantity of the water component and the said quantity of said hydrocolloid dietary fiber component are mixed to form a water and dietary fiber hydrocolloid mixture; and
b. said water dietary fiber hydrocolloid mixture is mixed with said quantity of a butter component to form said food product.

3. The method as recited in claim 1, wherein a ratio between the quantity of the water component by weight to the quantity of the hydrocolloid dietary fiber component to form the water dietary fiber hydrocolloid mixture is between about 1 to 0.5 and 1 to 4.

4. The method as recited in claim 3, wherein said ratio is between about 1 to 1 to 1 to 2.

5. The method as recited in claim 3, wherein said ratio is between about one to one and about one to one and a half.

6. The method as recited in claim 1, wherein said hydrocolloid dietary fiber component comprises one or more of the following dietary fibers either alone or in combination with one another, said dietary fibers comprising:
Arabic gum
Algin
Bensal
Locust bean tara
Karaya
Guar
Oat
Ghatti
Guince
Sapote
Watsonia
Tamarind
Psyllium
Tragacanth
Xanthan
Furcelleran
Dextran
Chondritin sulfate
Chitosan
Xylan
Propol
Carrageenan
Agar
Pectin

7. The method as recited in claim 1, wherein said hydrocolloid dietary fiber component comprises one or more of the following dietary fibers either alone or in combination with one another, namely, inulin locust bean gum, guar, psyllium, and pectin.

8. The method as recited in claim 1, wherein said hydrocolloid dietary fiber component comprises at least about one half inulin.

9. The method as recited in claim 1, wherein said hydrocolloid dietary fiber component comprises predominately inulin, ranging from all inulin to at least about three-quarters inulin.

10. The method as recited in claim 1, wherein the butter component is made by providing cream taken from milk of an animal or animals and adding another ingredient comprising one or more of a probiotic, prebiotic and/or other health enhancing components to said butter component, and then churning said cream to provide a health enhanced butter component which is combined with the water/dietary fiber hydrocolloid mixture to make the butter/dietary fiber/water product as a health enhancing product.

11. The method as recited in claim 1, further comprising providing said quantity of water component as a quantity of buttermilk MFGM.

12. The method as recited in claim 1, further comprising providing said quantity of said butter component by providing a quantity of cream and churning said quantity of cream to provide a quantity of butter as the quantity of the butter component and using a quantity of buttermilk MFGM which results from churning the cream as the water component that is mixed with the quantity the hydrocolloid dietary fiber component.

13. A food product arranged to reduce consumption of fat and increase consumption of dietary fiber, said food product comprising:
a. a quantity of a water component and a quantity of a dietary fiber which are combined to form a hydrocolloid mixture;
b. a further mixture of a quantity of a butter component and said hydrocolloid mixture, said further mixture being characterized in that said hydrocolloid mixture and said butter component are closely interspersed with one another to form an emulsion of said butter component, said fiber component, and said water component.

14. The product as recited in claim 13, wherein a ratio between the quantity of the water component by weight to the quantity of the hydrocolloid dietary fiber component to form the water dietary fiber hydrocolloid mixture is between about 1 to 0.5 and 1 to 3.

15. The product as recited in claim 14, wherein said ratio is between about 1 to 1 and 1 to 2.

16. The product as recited in claim 15, wherein said ratio is between about one to one and about one to one and a half.

17. The product as recited in claim 13, wherein said hydrocolloid dietary fiber component comprises one or more of the following dietary fibers either alone or in combination with one another, said dietary fibers comprising:
Arabic gum
Algin
Bensal
Locust bean tara
Karaya
Guar
Oat
Ghatti
Guince
Sapote
Watsonia
Tamarind
Psyllium
Tragacanth
Xanthan
Furcelleran
Dextran
Chondritin sulfate
Chitosan
Xylan
Propol
Carrageenan
Agar
Pectin

18. The product as recited in claim 13, wherein said hydrocolloid dietary fiber component comprises at least about one half inulin.

19. The product as recited in claim 13, wherein said hydrocolloid dietary fiber component comprises predominately inulin, and ranging from all inulin to at least about three-quarters inulin.

20. The product as recited in claim 13, wherein the butter component is made by providing cream taken from milk of an animal or animals and adding another ingredient comprising one or more of a probiotic, prebiotic and/or other health enhancing components to said butter component, and then churning said cream to provide a health enhanced butter component which is combined with the water/dietary fiber hydrocolloid mixture to make the butter/dietary fiber/water product.

21. A method of making an improved food product in a situation where there is an existing recipe for a previously established food product, with said recipe comprising a quantity of butter, said method comprising making a quantity of a substitute food product as follows:
a. providing a quantity of a water component and mixing said quantity of a water component with a quantity of a hydrocolloid dietary fiber component to form a water and dietary fiber hydrocolloid mixture;
b. mixing the water dietary fiber hydrocolloid mixture with a quantity of a butter component to form said substitute food product;
c. replacing at least a portion of the butter in the existing recipe with at least a portion of said substitute food product; and
d. completing the making of the improved food product in accordance with the recipe with said portion of the substitute food product

22. The method as recited in claim 21, wherein said existing recipe further comprises sugar, and the hydrocolloid dietary fiber component is at least one-half inulin, said method further comprising reducing the amount of sugar in the existing recipe in accordance with the degree of sweetness which would be added by the inulin to the substitute food product.

23. A method of continuously making a butter/dietary fiber/water product, comprising:
a. directing cream into a churn to form butter;
b. directing said butter from the churn into a first mixer;
c. directing a water component and a hydrocolloid dietary fiber component into a second mixer to form a water and dietary fiber hydrocolloid mixture;
d. directing said water and dietary fiber hydrocolloid mixture into said first mixer and operating said first mixer to mix the water and dietary fiber hydrocolloid mixture with the butter to form a butter/dietary fiber/water mixture which is characterized in that the hydrocolloid mixture and butter are closely interspersed with one another to form said butter/dietary fiber and water product which is then removed from the first mixer.

24. The method as recited in claim 23, wherein said butter/dietary fiber/water product is an emulsion.

25. The method as recited in claim 23, wherein said first mixer is a continuous mixer having an inlet section and a discharge section, with a mixing section being between the inlet section and the outlet section, said method comprising directing the butter to the inlet section of the first mixer and also directing the water and dietary fiber, hydrocolloid mixture into the inlet section, with the butter being mixed with the water and dietary fiber hydrocolloid mixture, with the butter/dietary fiber/water mixture being discharged from the discharge section.

26. The method as recited in claim 23, further comprising churning the cream to form in addition to the butter a buttermilk MFGM component which functions as the water component which is mixed with the hydrocolloid dietary fiber whereby the buttermilk MFGM from the cream is returned as a dairy product to the butter in the mixer to form a more complete dairy product that functions as the butter component.

27. A butter/dietary fiber/water food product made in accordance with the method of claim 1.
